(19) United States
(12) Patent Application Publication
(10) Pub. No.: US 2006/0188307 A1
(43) Pub. Date: Aug. 24, 2006

(54) Image formation device and image formation method

(75) Inventor: Takashi Inui, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/249,344

(22) Filed: Oct. 14, 2005

(30) Foreign Application Priority Data
Feb. 24, 2005 (JP) 2005-049280

(51) Int. Cl. G03G 15/00

(52) U.S. Cl. 399/396

(57) ABSTRACT

An image formation device has a transport component, an image formation section, a detection component and a controller. The transport component transports paper. The image formation section forms an image on the paper. The detection component detects a state of transport of the paper which is being transported by the transport component. The controller controls the transport component to locally vary a transport speed of the paper based on the state detected by the detection component.

### CROSS-REFERENCE TO RELATED APPLICATION

This application claims priority under 35 USC 119 from Japanese Patent Application No. 2005-49280, the disclosure of which is incorporated by reference herein.

### BACKGROUND

1. Technical Field

The present invention relates to an image formation device and an image formation method, and more specifically relates to an image formation device, an image formation method and a storage medium for forming images at paper at which it is possible to form a plurality of images continuously in a predetermined direction at respectively different regions.

2. Related Art

Heretofore, in an image formation device, guide holes for paper feeding have been formed in a long sheet of paper (continuous paper), and tractor pins pass through these paper feed guide holes and transport the paper. In this kind of image formation device, if a speed of rotation of a paper transport motor is controlled to be constant, there is no error between the number of rotations of the motor and feed amounts of the paper.

However, in recent years, there have been increasing demands for printing at, of continuous papers, papers without paper feed guide holes. Transporting and printing on paper without paper feed guide holes has the following problems.

Firstly, when paper feeding is implemented by a roller or the like, slight slippages will occur between a roller surface and the paper, and feed amounts according to the number of rotations of a motor will differ from feed amounts by which the paper is actually fed.

Secondly, when paper feeding is implemented by a roller or the like, feed amounts of the paper will vary slightly because of common difference in thickness of the paper, common difference in roller diameter, and such like.

If printing continues under the circumstances described above, there are differences between paper feeding speeds according to control and actual paper feeding speeds, and a writing position of printing in this state will be shifted. Therefore, it is necessary to alter a paper transport speed by some method, to set the transport speed to the proper paper feeding speed.

Now, even in paper feeding control with conventional tractor pins, controls to switch speeds are performed, and controls are implemented so as to divide up output pulses of an oscillator which is a basis of speed control, to lengthen a speed control pulse cycle and slow a speed of rotation of a paper feeding motor. However, in a case in which speed alteration of a pinless paper feeding device is performed by this control method, if a unit of alteration of speed were to be 1 in 10,000 or 1 in 100,000, an oscillation frequency of 10,000 or 100,000 times a clock frequency which is the basis of speed control of the paper feed motor would be required. Given that a realistic speed control pulse cycle is several μs (i.e., several kHz), in practice an oscillator of at least several GHz would be required for altering pulse cycles in small amounts by this method, and this is extremely difficult to implement.

### SUMMARY

The present invention has been made in view of the above circumstances and provides an image formation device, an image formation method and a storage medium for image formation.

An image formation device has a transport component, an image formation section, a detection component and a controller. The transport component transports paper. The image formation section forms an image on the paper. The detection component detects a state of transport of the paper which is being transported by the transport component. The controller controls the transport component to locally vary a transport speed of the paper based on the state detected by the detection component.

### BRIEF DESCRIPTION OF THE DRAWINGS

Embodiments of the present invention will be described in detail based on the following figures, wherein:

FIG. 1 is a schematic interior view of an image formation device of embodiments of the present invention;

FIG. 2 is a block diagram showing a control system of the image formation device of the embodiments of the present invention;

FIGS. 3A to 3C are timing charts showing operations of the embodiments of the present invention;

FIG. 4 is a block diagram showing a control system of an image formation device relating to a second embodiment of the present invention; and

FIG. 5 is a block diagram of a speed control circuit of a third embodiment of the present invention.

### DETAILED DESCRIPTION

Below, an example of an embodiment of the present invention will be described in detail with reference to the drawings.

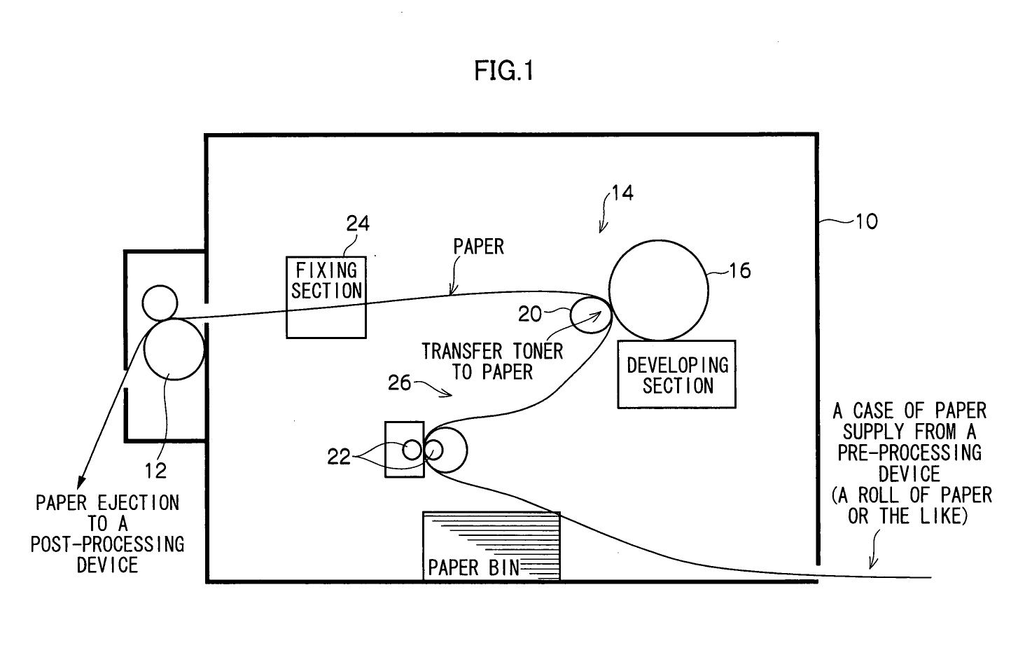

As shown in FIG. 1, an image formation device 10 has an image formation section 14. The image formation section 14 forms images at paper which is transported by a paper feed roller 12. The image formation section 14 also has a photosensitive body 16 for bearing a toner image, a charging unit, an optical scanning section, a developing section, a transfer section and so forth.

In the present embodiment, a transport path, for transporting the paper so as to come into contact with the image formation section 14, is provided. At a transport direction downstream side of the transport path relative to the image formation section 14, a fixing section 24 and the paper feed roller 12 are provided. At a transport direction upstream side of the transport path relative to the image formation section 14, a back tension portion (a tension roller) 22 is provided.

Here, marks have been formed at the paper beforehand at predetermined intervals (lengths corresponding to single image formation regions). The image formation device 10 has a paper speed detection sensor 26, which detects these marks. Herein, the marks could be formed on the paper by the image formation section 14. In such a case, the paper speed detection sensor 26 will be disposed at the transport direction downstream side of the transport path relative to the image formation section 14.

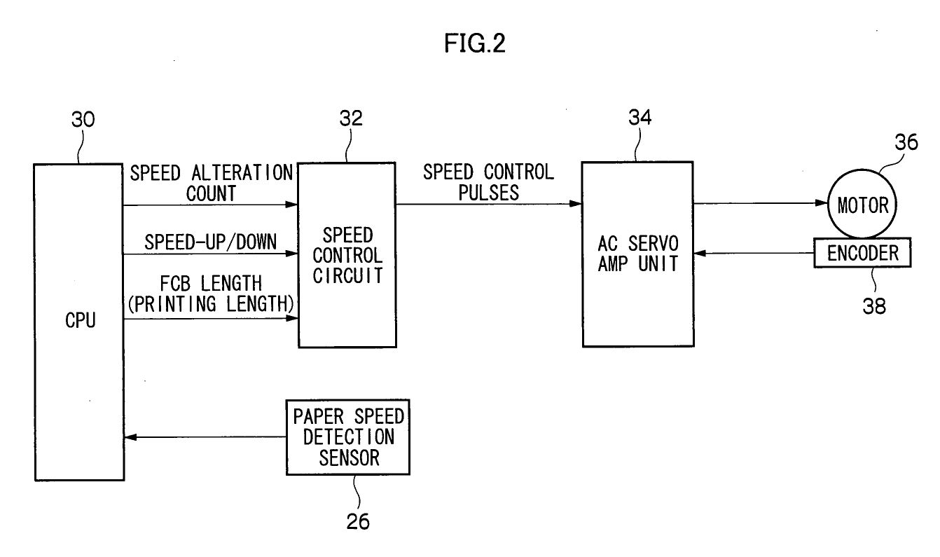

As shown in FIG. 2, a control system of this image formation device 10 has a CPU 30, a motor 36, an AC servo amp unit 34 and a speed control circuit 32. The motor 36 causes the paper feed roller 12 to rotate. The AC servo amp unit 34 controls a turning angle of the motor 36 in accordance with input pulses. The speed control circuit 32 controls the AC servo amp unit 34 by outputting speed control pulses, which will be discussed later. Herein, the above-mentioned paper speed detection sensor 26 is connected to the CPU 30.

When the paper feed roller 12 turns in a predetermined direction, the paper is transported. In the state in which the paper is being transported, the image formation section 14 forms an image and transfers the image with a transfer roller 20. The image that has been transferred to the paper is fixed by the fixing section 24.

Herein, a predetermined tension is applied to the paper by the tension roller 22.

The image formation device 10 performs transport with the paper feed roller 12, slippage may occur between a surface of the roller 12 and the paper, and a transport speed of the paper may change. If the paper transport speed changes, a position of writing onto the paper will shift, and an accurate image will not be formed. Accordingly, in the present embodiment, the paper transport speed is controlled as follows.

As mentioned above, the marks are formed at predetermined intervals on the paper beforehand. The paper speed detection sensor 26 sequentially detects these marks, and a detection signal is outputted to the CPU 30 at the time of each detection. Each time a detection signal from the paper speed detection sensor 26 is inputted at the CPU 30, the CPU 30 calculates a detection interval T1 and compares the same with a pre-specified ideal value T. This ideal value T is an interval at which the marks will be detected by the paper speed detection sensor 26 if the paper feed roller 12 is transporting the paper correctly.

If the detected interval T1 and the ideal value T differ, it is understood that transportation of the paper by the paper feed roller 12 is not transporting at a pre-specified speed. In the present embodiment, if the detected interval T1 is compared with the ideal value T and the detected interval T1 is larger than the ideal value T, the paper transport speed is slow. Hence, a speed-up signal, which is an instruction to increase the transport speed, is outputted to the speed control circuit 32. In contrast, if the detected interval T1 is smaller than the ideal value T, the paper transport speed is fast. Hence, a speed-down signal, which is an instruction to lower the paper transport speed, is outputted to the speed control circuit 32.

In addition, on the basis of a difference (offset) between the ideal value T and the detected interval T1, the CPU 30 outputs a speed alteration count to the speed control circuit 32. The speed alteration count is a number of pulses that are to be adjusted in a duration in which a paper length at which a single image is to be formed is transported. Further, the CPU 30 outputs an FCB length (a printing length, which is the length of paper for the formation of a single image) to the speed control circuit 32.

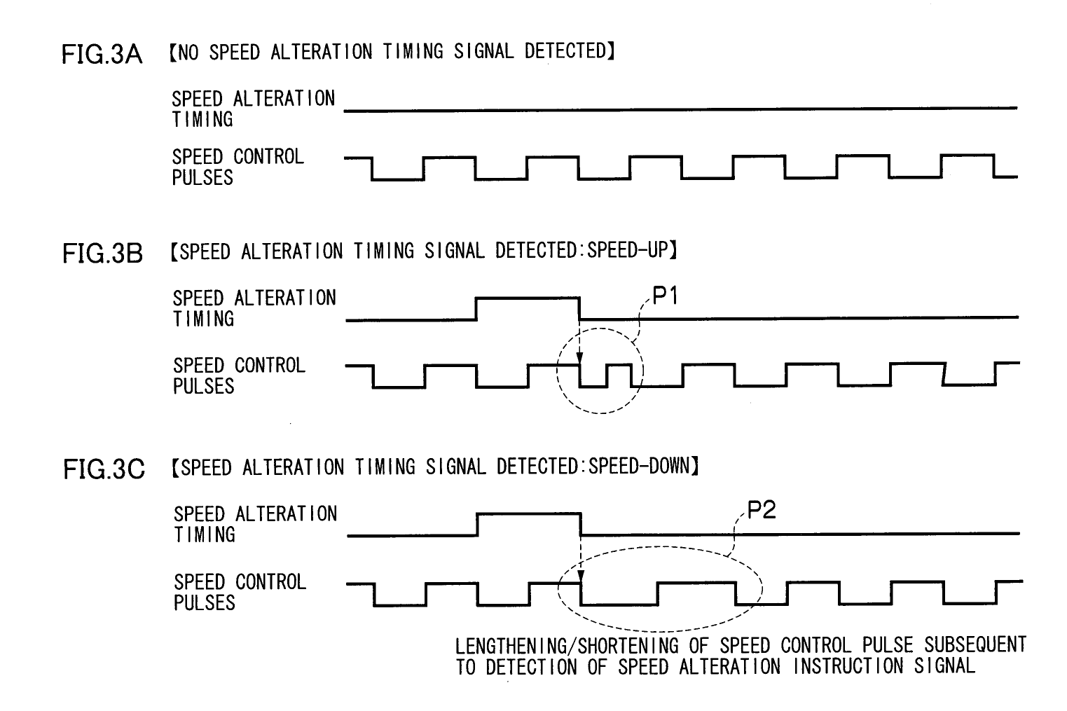

The speed control circuit 32 calculates an interval (a pulse count) for adjustment of single pulses, by dividing an output number of speed control pulses corresponding to the FCB length by the speed alteration count. For example, if a pulse count for one page is 10,000 pulses and the number of pulses to be adjusted in one page, according to the difference (offset) between the detected interval T1 and the ideal value T, is 10, then 10,000÷10=1,000. That is, one pulse in each 1,000 pulses will be adjusted. Accordingly, the speed control circuit 32, having found this interval for adjustment of single pulses, internally generates a speed alteration timing signal, as shown in FIGS. 3B and 3C, for each occasion of output of a speed control pulse corresponding to the calculated interval. Specifically, in the example described above, the speed control circuit 32 internally generates a speed alteration timing signal each time 1,000 of the speed control pulses have been outputted to the AC servo amp unit 34. At a time of falling of this speed alteration timing signal, the speed control circuit 32 temporarily alters the period of the speed control pulses, in accordance with the speed-up signal or speed-down signal, and outputs a speed control pulse to the AC servo amp unit 34. That is, if the detected interval T1 is greater than the ideal value T (when the speed is slow), in order to temporarily increase the speed, as shown in FIG. 3B, the speed control pulse that is to be outputted next after the fall of the speed alteration timing signal is outputted to the AC servo amp unit 34 in the form of a short-period speed control pulse P1, which has a small width and an interval shorter than a usual output interval. Rotation of the motor 36 is locally accelerated by this speed control pulse P1, a speed of rotation of the paper feed roller 12 is locally accelerated and, correspondingly, the paper transport speed is locally accelerated.

On the other hand, if the detected interval T1 is smaller than the ideal value T (when the transport speed is fast), the speed control pulse that is to be outputted next after the fall of the speed alteration timing signal is outputted to the AC servo amp unit 34 in the form of a long-period speed control pulse P2, which has a large width and an interval longer than a usual output interval. As a result, rotation of the motor 36 is slowed, rotation of the paper feed roller 12 is slowed, and the paper transport speed is slowed.

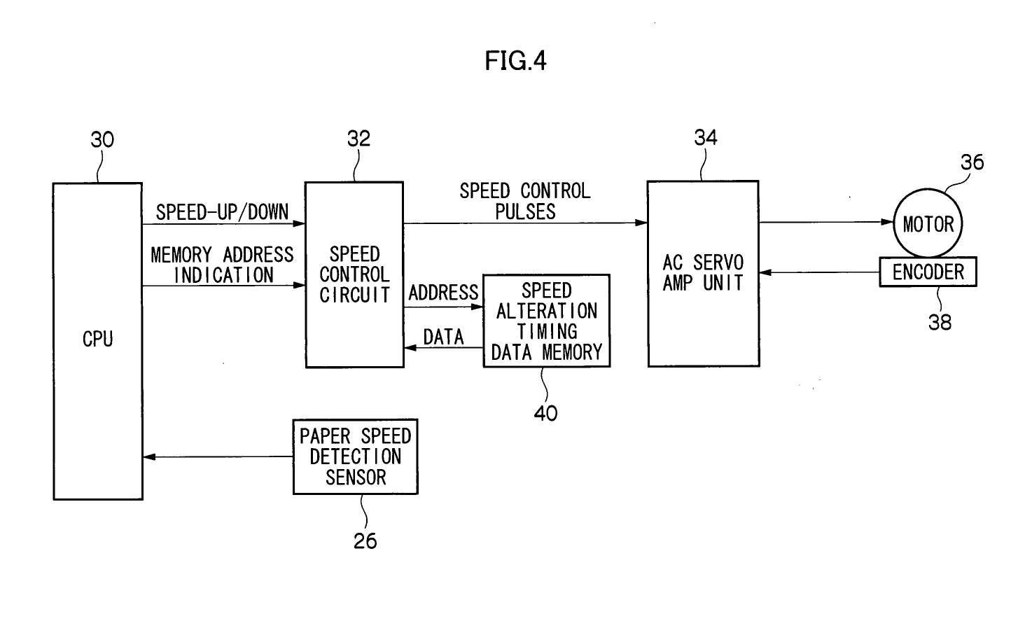

Next, a second embodiment of the present invention will be described. An image formation apparatus relating to the present embodiment has a similar structure to the first embodiment. Therefore, the same reference numerals are applied to portions that are the same and descriptions thereof are omitted, and only portions which differ will be described. As shown in FIG. 4, a control system of the image formation device 10 of the present embodiment has a speed alteration timing data memory 40, which is connected with the speed control circuit 32. At the speed alteration timing data memory 40, pulse counts for adjustment of single pulse are stored. Each memory region is designated by a respective memory address, and these memory addresses are stored at the CPU 30.

The CPU 30 calculates how many pulses are to be adjusted, from a difference between the detected interval T1 and the ideal value T. From the thus-calculated number of pulses to be adjusted, the CPU 30 calculates the pulse count of an interval for adjustment of single pulse and, in order to designate intervals at which single pulse is to be adjusted, the CPU 30 outputs a memory address corresponding to the calculated interval to the speed control circuit 32. Hence, in accordance with the designated memory address, the speed control circuit 32 inputs data from the speed alteration timing data memory 40, and acquires information on after how many pulses a single pulse is to be adjusted. The speed control circuit 32 outputs the speed alteration timing signals accordingly. As in the first embodiment described above, when the detected interval T1 is greater than the ideal value T, the speed control circuit 32 outputs the speed control pulse P1 (see FIG. 3B) in accordance with the fall of a speed alteration timing signal, and when the detected interval T1 is smaller than the ideal value T, the speed control circuit 32 outputs the speed control pulse P2 when a speed alteration timing signal falls, as shown in FIG. 3C.

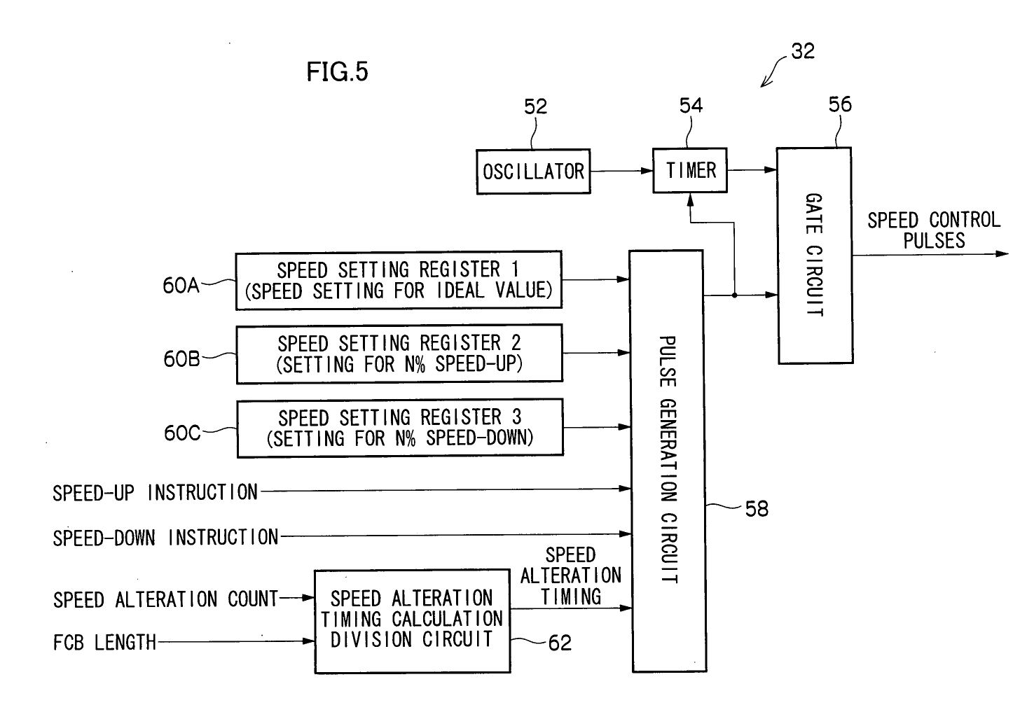

Next, a third embodiment of the present invention will be described. Structures of the present embodiment are substantially similar to the first embodiment. Therefore, descriptions thereof are omitted. However, as shown in FIG. 5, the speed control circuit 32 has an oscillator 52, a timer 54, a gate circuit 56 and a pulse generation circuit 58. The oscillator 52 generates a signal with a predetermined interval. The timer 54 forms the signal outputted from the oscillator 52 into a signal with a predetermined period. The gate circuit 56 outputs these signals, giving precedence to signals from the pulse generation circuit 58 over signals from the timer 54. Herein, when a signal is inputted to the timer 54 from the pulse generation circuit 58, the timer 54 is reset. Therefore, signals from the pulse generation circuit 58 to the output of the timer 54 have the form of interrupts. Speed setting registers 60A, 60B and 60C are connected to the pulse generation circuit 58. At the pulse generation circuit 58, clock signals are inputted from the oscillator 52 in order to obtain synchronization with outputs of the timer 54, and speed-up signals and speed-down signals are inputted from the CPU 30. The FCB length and speed alteration count are inputted from the CPU 30 to a speed alteration timing calculation division circuit 62. The speed alteration timing calculation division circuit 62 divides the FCB length by the speed alteration count, and hence generates speed alteration timing signals and outputs the speed alteration timing signals to the pulse generation circuit 58. When a speed alteration timing signal is inputted at the pulse generation circuit 58, the pulse generation circuit 58 generates a speed control signal with a pulse width in accordance with the speed-up signal or speed-down signal and in accordance with a setting value selected from the speed setting registers 60A, 60B and 60C. The pulse generation circuit 58 outputs this speed control signal to the gate circuit 56, and outputs the same to the timer 54 as a reset signal.

When a speed alteration timing signal is outputted from the division circuit 62, if both speed-up and speed-down instructions are off, a speed control pulse is determined by the value of the speed setting register 60A, and an ideal speed control pulse is outputted by the pulse generation circuit 58 and the gate circuit 56.

If the speed-up signal has been set to on when the speed alteration timing signal is outputted, the speed control pulse is made faster by the value in the speed setting register 60B (pulse P1 is outputted, as in FIG. 3B). On the other hand, if the speed-down signal has been set to on when the speed alteration timing signal is outputted, the speed control pulse is made slower by the value in the speed setting register 60C (pulse P2 is outputted, as in FIG. 3C).

In the first embodiment, second embodiment and third embodiment as described above, it is possible to lengthen and shorten the cycle of a speed control pulse at a number of times in an FCB length (the printing length of one page) and, by lowering the frequency of an oscillator which is the basis of speed control (which frequency will in practice be several MHz), it is possible to finely alter the paper feeding speed, and to adjust the transport speed simply.

Further, it is possible to remedy paper feeding amount errors, shifts in a writing position of printing, common difference happened by mechanical factors and slippage, for pinless paper-feeding of continuous paper.

Further, in a case of, for example, multiple printing (printing in which continuous long paper passes through two printing devices), if printing is performed without employing the present invention, paper feeding speeds will differ between the first and second machines because of slipping at paper feed rollers, common difference in roller diameters and so forth. Thus, even if the numbers of rotations of the paper feed rollers are the same, there will be variations in a paper buffer which has been provided at a time of installation, and paper tearing or excessive slackness of the paper will occur. Therefore, it will be necessary to monitor the amount of the paper buffer.

However, according to the present invention, even if there is a difference between the first and second machines due to slipping at paper feed rollers, common difference in roller diameters and the like, the paper feeding speeds of the first and second machines can be kept similar. Therefore, paper tearing, excessive slackness of paper and the like will not occur at a paper buffer section.

Further, in the case of multiple printing, a surface is printed at the second machine after having been printed (and fixed) at the first machine. However, there is a tendency for the paper that has been printed (and fixed) at the first machine to contract. However, if a present embodiment is utilized and speed alterations are implemented with speed control pulse cycle alteration counts and speed alteration timings calculated from the duration of passage of printing marks or the like, it is possible to print such that durations of passage of the printing marks are the same at the first and second machines. Thus, it is possible to match up printing lengths of the first and second machines. Furthermore, it is also possible to prevent a reduction in a paper buffer amount due to the shrinkage of the paper.

Because there is periodicity in the speed alteration timings in the first embodiment described above, there is a possibility that the periodicity of the speed alterations will be apparent in a printout of a printing pattern. Accordingly, in the second embodiment, variable-count or random alteration timings can be stored and the periodicity of the alteration timings eliminated. Thus, it is possible to prevent the periodicity from appearing in printouts.

According to the first aspect of the present invention, an image formation device includes: a transport component, which transports paper at which it is possible to form a plurality of images continuously in a predetermined direction at respectively different regions in the form of a row; an image formation section, which forms an image at the paper; a detection component, which detects a state of transport of the paper which is being transported by the transport component; and a controller, which controls the transport component so as to locally vary a transport speed of the paper, in accordance with the state of transport of the paper detected by the detection component, during transport of a paper length at which a single image is to be formed.

That is, the transport component transports the paper (a long belt of paper) at which it is possible to form a plurality of images continuously, in a row in a predetermined direction, at respective different regions. The image formation portion forms images at the paper. Herein, the image formation portion forms the images in a state in which the paper is being transported.

The detection component detects a transport state of the paper that is being transported by the transport component. The detection component may be formed to, for example, directly detect a paper transport speed, or to detect a physical quantity corresponding to transport speed by detecting marks which have been formed, beforehand or by the image formation portion, at predetermined intervals on the paper.

Then, on the basis of the paper transport speed detected by the detection component, the controller controls the transport component so as to locally vary the paper transport speed while the paper length at which the single image is being formed is being transported. Here, the length of the paper at which the single image is formed is a length in the transport direction of the paper.

Thus, in the present invention, the paper transport speed is locally varied during the transport of the paper length at which the single image is to be formed and, if the transport component is controlled with a predetermined interval, the predetermined interval itself need not be controlled over the whole duration of the transport of the paper length at which the single image is to be formed. Therefore, it is possible to adjust the paper transport speed simply during the transport of the paper length at which the single image is to be formed.

Herein, the controller controls the transport component with a predetermined interval, and locally alters the predetermined interval. Thus, the controller controls the transport component so as to locally vary the transport speed of the paper.

Thus, even in a case of controlling the transport component with a predetermined interval, the predetermined interval is altered only locally; the predetermined interval itself is not controlled over the whole duration of transport of the paper length at which the single image is to be formed. Thus, it is possible to regulate the paper transport speed simply during the transport of the paper length at which the single image is to be formed.

Furthermore, the controller may specify a number of times that the transport component is to be controlled to vary the paper transport speed locally during the transport of the paper length at which the single image is to be formed, and may control the transport component so as to locally vary the paper transport speed the specified number of times. In such a case, the controller may control the transport component such that portions at which the paper transport speed is to be varied, based on the length of the paper at which the single image is to be formed and the specified number of times, are evenly distributed in the duration of transport of the paper length at which the single image is to be formed.

Further yet, it is possible to provide a memory which stores a plurality of intervals which will express the portions at which the paper transport speed will be varied while the paper length at which the single image is to be formed is being transported, and the controller may control the transport component such that the portions at which the transport speed of the paper is to be varied are expressed, during the transport of the paper length at which the single image is to be formed, with an interval selected from the plurality of intervals stored in the memory.

According to the present invention as described above, the paper transport speed is locally varied while the paper length at which the single image is being formed is being transported. Thus, there is an advantage in that it is possible to adjust the paper transport speed simply during transport of the paper length at which the single image is to be formed.

What is claimed is:

1. An image formation device comprising:
a transport component that transports paper;
an image formation section that forms an image on the paper;
a detection component that detects a state of transport of the paper which is being transported by the transport component; and
a controller that controls the transport component to locally vary a transport speed of the paper based on the state detected by the detection component.

2. The image formation device according to claim 1, wherein the paper has a plurality of
images continuously in a predetermined direction at respectively different regions.

3. The image formation device according to claim 1, wherein the controller controls the transport component during transport of a paper length at which a single image is to be formed.

4. The image formation device according to claim 1, wherein the controller controls the transport component with a predetermined interval, and controls the transport component to locally vary the transport speed of the paper by locally altering the predetermined interval.

5. The image formation device according to claim 1, wherein the controller specifies a number of times to control the transport component, and controls the transport component to locally vary the transport speed of the paper based on the specified number of times.

6. The image formation device according to claim 5, wherein the controller controls the transport component such that a portion at which the transport speed of the paper is varied, based on the length of the paper at which the single image is to be formed and the specified number of times, are evenly distributed during transport of the paper length at which the single image is to be formed.

7. The image formation device according to claim 1, further comprising
a memory that stores a plurality of intervals which express portions at which the transport speed of the paper is varied;
wherein the controller controls the transport component such that the portions at which the transport speed of the paper is to be varied are expressed, during transport of the paper length at which the single image is to be formed, with an interval selected from the plurality of intervals stored in the memory.

8. An image formation method comprising:
transporting paper;
forming an image on the paper;
detecting a state of transport of the paper which is being transported; and
controlling the transport to locally vary a transport speed of the paper based on the state.

9. The image formation method according to claim 8, wherein the paper has a plurality of
images continuously in a predetermined direction at respectively different regions.

10. The image formation method according to claim 8, wherein the transport speed of the paper is varied while a paper length at which a single image is to be formed is transported.

11. The image formation method according to claim 8, wherein a number of times to control the transport is specified, and the transport speed is locally varied based on the specified number of times.

12. The image formation method according to claim 11, wherein the transport speed is varied based on the length of the paper at which the single image is to be formed and the specified number of times, and portions which the transport speed is varied are evenly distributed during transport of the paper length at which the single image is to be formed.

13. The image formation method according to claim 8, further comprising
a memory that stores a plurality of intervals which express portions at which the transport speed of the paper is varied;
wherein the transport speed of the paper is varied, during transport of the paper length at which the single image is to be formed, with an interval selected from the plurality of intervals stored in the memory.

14. The image formation method according to claim 8, wherein the transport speed is varied by a predetermined interval.

15. A storage medium readable by a computer, the storage medium storing a program of instructions executable by the computer to perform a function for image formation, the function comprising:
transporting paper;
forming an image on the paper;
detecting a state of transport of the paper which is being transported; and
controlling the transport to locally vary a transport speed of the paper based on the state.
